(19) United States
(12) Patent Application Publication
(10) Pub. No.: US 2025/0365339 A1
(43) Pub. Date: Nov. 27, 2025

(54) MACHINE LEARNING CLOUD SERVICES INTELLIGENCE

(71) Applicant: Open Text Inc., Menlo Park, CA (US)

(72) Inventors: Thomas Sheffield Dalton, San Diego, CA (US); Joseph Rombs, Menlo Park, CA (US)

(21) Appl. No.: 18/673,025

(22) Filed: May 23, 2024

(51) Int. Cl. H04L 67/02; H04L 67/56

(52) U.S. Cl. CPC H04L 67/02; H04L 67/56

(57) ABSTRACT

A computer-implemented method for activity monitoring with respect to online services. The method can include accessing a machine learning multiclass classifier, the machine learning multiclass classifier representing HTTP network request features and associated actions with respect to interacting with websites, receiving an HTTP request, extracting a feature set from the HTTP request, determining a request action classification for the HTTP request, determining the request action classification comprising processing the feature set extracted from the HTTP request to the machine learning multiclass classifier to classify the HTTP request, and providing access to the HTTP request and request action classification via an application programming interface.

### TECHNICAL FIELD

This disclosure relates to the use of web services. More particularly, this disclosure relates to accurately classifying cloud services actions for risk assessment and policy enforcement. Even more particularly, this disclosure relates to systems and methods for controlling access to cloud services using a machine learning model.

### BACKGROUND

Cloud services provide many beneficial features that allow individuals to store and share data and collaborate with others. Increased access to data, however, brings with it an increased risk of data loss. As organizations integrate with more cloud services, administrators are finding it increasingly difficult to manage access levels and application use by employees to prevent them from inappropriately taking or sharing the organization's data. Moreover, with the growth in remote work, employees are increasingly using unsanctioned, and potentially unsecure, devices to access data.

Some organizations attempt to mitigate the risks presented by cloud services by preventing employees from using the services inappropriately, typically by blocking all requests to blacklisted cloud services or by applying hard-coded rules to block certain types of requests. Such solutions, however, have several shortcomings. First, an organization may still find it beneficial to allow individuals to use some features of a cloud service, which the organization cannot do if the cloud service is blacklisted. Second, cloud services change their back-end application programming interfaces (APIs) over time, which can cause a blacklist or rules database to fall out of date. Consequently, the provider of a blacklist or rules database must frequently rediscover the cloud applications that have changed and then update the rules accordingly, which is costly and inefficient. Moreover, since the changes to the cloud application are not discovered until after the fact, there is often a period during which the blacklist or rules fail to block potentially risky requests.

### SUMMARY

Embodiments of the present disclosure provide systems and methods for monitoring the actions requested with respect to cloud services. Embodiments can further take security actions or other actions based on the classifications of requests to or responses from online services.

One general aspect of the present disclosure includes a computer-implemented method. The computer-implemented method includes accessing a machine learning multiclass classifier, the machine learning multiclass classifier representing HTTP network request features and associated actions with respect to interacting with websites. The method also includes receiving an HTTP request. The method also includes extracting a feature set from the HTTP request. The method also includes determining a request action classification for the HTTP request, determining the request action classification may include processing the feature set extracted from the HTTP request to the machine learning multiclass classifier to classify the HTTP request. The method also includes providing access to the HTTP request and request action classification via an application programming interface.

Another general aspect of the present disclosure includes a non-transitory, computer-readable medium storing thereon computer-executable instructions executable by a processor for: accessing a machine learning multiclass classifier, the machine learning multiclass classifier representing HTTP network request features and associated actions with respect to interacting with websites. The computer-executable instructions also include instructions for receiving an HTTP request, extracting a feature set from the HTTP request, and determining a request action classification for the HTTP request, where determining the request action classification may include processing the feature set extracted from the HTTP request using the machine learning multiclass classifier to classify the HTTP request. The computer-executable instructions may also include instructions providing access to the HTTP request and request action classification via an application programming interface.

Another general aspect of the present disclosure includes a computer system comprising client computing devices that run client applications. The system also includes a proxy server computer coupled to the client computing devices by a network, the proxy server computer may include a processor, a machine learning multiclass classifier representing HTTP network request features and associated actions with respect to interacting with websites, and proxy server code executable by the processor to provide a proxy server. The proxy server code may comprise instructions for receiving HTTP requests from the client applications, determining associated request action classifications for the HTTP requests, providing access to the HTTP requests and request action classifications. Determining the request action classifications my include using the machine learning multiclass classifier to classify the HTTP requests.

Some embodiments include one or more of the following features. The HTTP request is received, the feature set extracted, and the request action classification determined at an HTTP proxy server. The feature set includes one or more of the following: a method feature, a URL feature, a domain feature, a header feature, or a cookie feature. The feature set includes a method feature, a URL feature, a domain feature, a header feature, and a cookie feature. The request action classification classifies the HTTP request as an upload request. The request action classification classifies the HTTP request as a download request. The machine learning multiclass classifier is trained to classify requests as upload requests, download requests, or other requests. The request action classification for the HTTP request is provided to a downstream component for further processing of the HTTP request. The HTTP request and the request action classification are provided to a process that automatically initiates a task based on the request action classification. The task comprises at least one of performing a deep packet inspection, allowing the request, blocking the request, or logging the request in a security log.

Another general aspect includes a computer-implemented, activity monitoring machine learning method. The method includes transforming HTTP network requests into feature vectors, each feature vector representing selected features from a corresponding HTTP network request and an action selected from a plurality of actions to be monitored; and inputting the feature vectors into a machine learning model to train the machine learning model to classify new HTTP requests according to the plurality of actions, where the plurality of actions include an upload action and a download action.

Another general aspect of the present disclosure includes a non-transitory, computer-readable medium storing thereon computer-executable instructions executable by a processor for: transforming HTTP network requests into feature vectors, each feature vector representing selected features from a corresponding HTTP network request and an action selected from a plurality of actions to be monitored; and inputting the feature vectors into a machine learning model to train the machine learning model to classify new HTTP requests according to the plurality of actions, where the plurality of actions include an upload action and a download action.

Some embodiments include one or more of the following features. The selected features include one or more of an HTTP method feature, a URL feature, a domain feature, a header feature, or a cookie feature. The selected features include an HTTP method feature, a URL feature, a domain feature, a header feature, and a cookie feature. Converting the HTTP network requests into the feature vectors may include, for a selected HTTP request that may include an HTTP method, a URL, a domain, a header and a cookie: transforming the HTTP method to a first feature vector; transforming the URL to a second feature vector; transforming the domain to a third feature vector; transforming the header to a fourth feature vector; and generating an overall feature vector for the HTTP request. Generating the overall feature vector for the selected HTTP request may include concatenating a plurality of feature vectors including the first feature vector, the second feature vector, the third feature vector, and the fourth feature vector. The URL includes a query string and the second feature vector represents the URL, including the query string. The HTTP requests may include exemplar upload requests and exemplar download requests to a plurality of cloud applications. The plurality of actions includes at least one additional action. The HTTP network requests may include HTTP request bodies and where the HTTP network requests are transformed into the feature vectors without transforming the HTTP request bodies. The machine learning model is trained to classify the new HTTP requests according to the plurality of actions regardless of any body content of the new HTTP requests by considering only non-body features of the new HTTP requests. The machine learning model is a multiclass classifier.

Some embodiments of the present disclosure provide an advantage by providing the capability to block users from using some features of a web service without blocking the web service completely.

Embodiments can also provide a technical advantage by providing the capability to accurately classify requests to websites/services, including cloud services, even when the requests change due to changes in the back-end API of the site/service.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1A is a diagrammatic representation of one embodiment of a cloud services intelligence system configured to classify requests to cloud services.

FIG. 1B is a diagrammatic representation of one embodiment of a cloud services intelligence system configured to classify responses from cloud services.

FIG. 2 is a diagrammatic representation of one embodiment of a hypertext transfer protocol (HTTP) request and response flow.

FIG. 3 is a diagrammatic representation of one embodiment of a machine learning classifier.

FIG. 4 illustrates an example HTTP request and an example HTTP response.

FIG. 5A and FIG. 5B are diagrammatic representations of one embodiment of a request object.

FIG. 6 illustrates one embodiment of a response object.

FIG. 7 is a flowchart illustrating one embodiment of a method for training a classifier to classify requests or responses according to requested actions.

FIG. 8 is a flowchart illustrating one embodiment of a method for classifying requests to online services according to requested actions.

FIG. 9 is a flowchart illustrating one embodiment of a method for controlling allowable actions with respect to web services.

FIG. 10 is a diagrammatic representation of another embodiment of a cloud services intelligence system.

FIG. 11 is a diagrammatic representation of one embodiment of an operating environment in which one or more of the present embodiments may be implemented.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments of the present disclosure provide machine-learning based systems and methods to classify requests based on purpose. Classifying requests using machine-learning in this manner enables an organization to identify and prevent activities that could lead to data loss or other undesirable effects and can be used to set up and enforce policies pertaining to cloud application use.

Even more particularly, some embodiments classify network requests based on the purpose of the request—that is, the type of action the user is performing or attempting to perform using the cloud services. Example action classifications include, but are not limited to login, share, search, create, upload, delete, download, like, edit, post, comment. The classification of requests can be used to control actions being performed on cloud applications to prevent data loss, reputational loss, or other undesirable results. Further, the classification of requests can be used to track anomalous activity associated with actions being performed on cloud applications to identify risky or harmful behavior.

According to one embodiment, the machine learning model is a multiclass classifier that classifies network requests into several categories. In an even more particular embodiment, the machine learning model classifies hypertext transfer protocol (HTTP) requests (including HTTPs requests, in some embodiments). The machine learning model is trained to identify general patterns corresponding to actions. Thus, the machine learning model can continue to accurately classify requests to websites/services, including cloud services even when the requests change due to a change in back-end API of the site/service. Furthermore, the model can be retrained over time to prevent the model from becoming out of date.

Rules can be applied to the classifications to block requests or take other actions with respect to requests that represent risks. Various downstream tasks, such as deep packet inspection (DPI), allowing/denying requests, recording security logs, or other tasks can be performed based on the classifications.

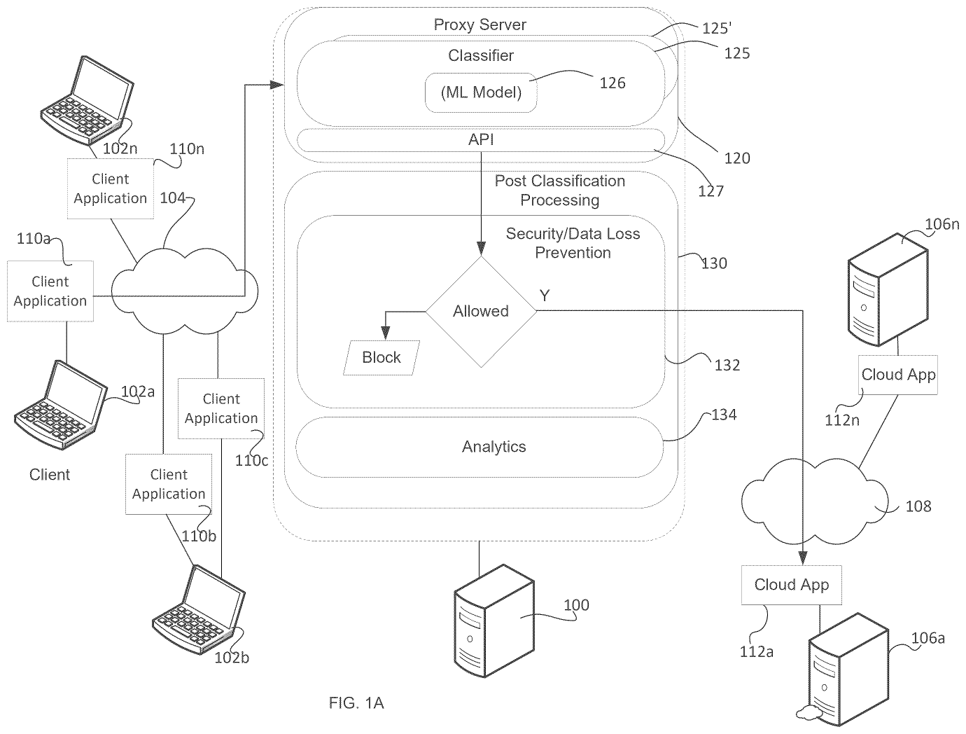

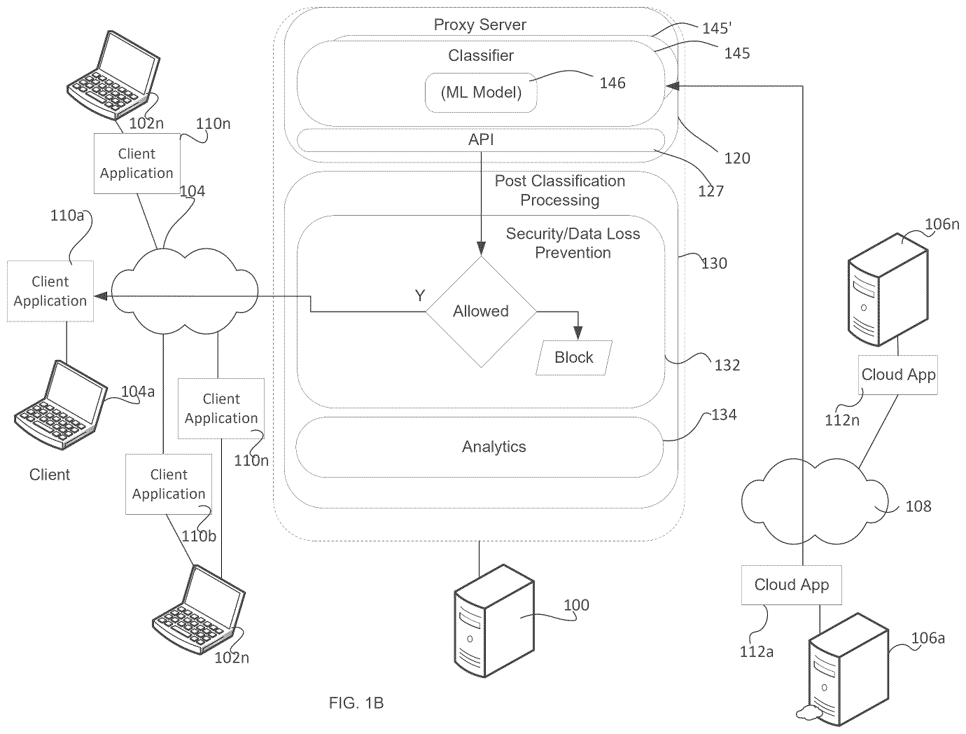

FIG. 1A is a diagrammatic representation of one embodiment of a cloud services intelligence system 100 configured to classify requests to cloud services. Cloud services intelligence system 100 Cloud services intelligence system 100 comprises one or more server computers communicatively coupled to client computers (e.g., client computer 102a, client computer 102b . . . client computer 102n (generally “client computers 102”) are illustrated) over a first network 104 and to cloud computing systems (e.g., cloud computing system 106a . . . cloud computing system 106n (referred to generally as “cloud computing systems 106”) over a second network 108. In one embodiment, cloud services intelligence system 100 comprises one or more server computers that are connected to client computers 102 over an intranet, such as a local area network (LAN) or virtual local area network (VLAN), and to cloud computing systems 106 over the Internet. While FIG. 1A illustrates cloud services intelligence system 100 as connecting between network 104 and network 108, this is for convenience to illustrate that cloud services intelligence system 100 is in the request/response path between clients on network 104 and services available over network 108. It will be appreciated that other types of networking equipment may act to physically connect network 104 to network 104.

Client computers 102 run client applications (e.g., client application 110a, client application 110b, client application 110c . . . client application 110n (referred to generally as “client applications 110) are illustrated). Cloud computing systems 106 run applications in the cloud (e.g., cloud application 112a . . . cloud application 112n (referred to generally as “cloud applications 112”) are illustrated) to provide cloud services, such as collaboration platforms, cloud-based file storage, social media sites, or other cloud services.

Cloud services intelligence system 100 comprises a proxy server 120 through which requests from network 104 to cloud services may be routed. Proxy server 120 includes a machine learning classifier 125 to classify requests from client applications. Cloud services intelligence system 100, in the illustrated embodiment, further includes post-classification processing components 130, such as a data loss prevention service 132 and analytics component 134. According to one embodiment, one or more of the components of cloud services intelligence system 100 are implemented through the execution of computer code by one or more server computers or other computer hardware.

Client applications 110 or components of network 104 are configured such that requests by client applications 110 to the Internet are routed to proxy server 120, which acts as an intermediary between client applications 110 on network 104 and web services provided over network 108. Proxy server 120 classifies requests using machine learning classifier 125. Downstream components can use the classifications for analytics or to implement tasks with respect to the requests. For example, data loss prevention service 132 can use the class assigned to a request to block or allow the request.

Machine learning classifier 125 comprises one or more machine learning models 126 trained to classify requests based on requested interactions with, for example, cloud services. Examples of action classes (labels) that reflect interactions with cloud services include, but are not limited to, Login, Share, Search, Create, Upload, Delete, Download, Like, Edit, Post, and Comment. These classes reflect common actions taken with respect to cloud services, such as, logging in, sharing resources (e.g., files, folders, comments, posts, or other objects) with other users, creating resources, uploading files or other data, downloading resources, posting to social media, editing existing contenting, liking existing content, and commenting on existing content.

Classifier 125 may utilize an artificial neural network (ANN), a decision tree, association rules, inductive logic, a support vector machine, clustering analysis, or Bayesian networks, among other examples. In some embodiments, classifier 125 includes multiple machine learning models 126 for different feature sets or different use cases. For example, classifier 125 may include a machine learning model 126 trained on a first feature set, a second machine learning model trained on a second feature set, a third machine learning model trained on a third feature set and so on. The resulting classification scores generated by each ML model may then be combined into a final classification score using a decision tree or other technique. In yet another example of feature classification evaluation, a classification may be subdivided into a multi-class classification problem defined by the label set for classifier 125. For example, for a classifier 125 to classify requests according to the label space of Upload, Download, Other, a classification may be subdivided into a three-class classification problem defined by Upload requests, Download requests and Other requests. The resulting multi-class problem can be solved using multi-class classification (e.g., Directed Acyclic Graph (DAG) support vector machine or other multi-class classification techniques).

Classifier 125 is trained using a training corpus of HTTP requests in which the requests are labeled according to the label space for classifier 125. In other words, classifier 125 is trained from a collection of data that includes requests that are known to be of each class for which the classifier is trained. For example, classifier 125 can be trained to classify requests as Upload, Download, or Other from a collection of data including known Download requests and known Upload requests. In some embodiments, Other is not a trained category but a catchall category used by classifier 125 if it cannot classify a request into Upload or Download with a threshold degree of confidence. In other embodiments, the collection of data used to train classifier 125 includes known Other requests (requests that are known not to be Upload or Download requests).

In a training stage, collected requests are analyzed to identify features that may indicate that a request belongs to a class. Any number of features may be collected and analyzed for a request. During training, feature selection (feature pruning) techniques can be used to reduce the number of features to those that best discriminate between the classes of the label space.

In a classification stage, proxy server 120 routes requests to classifier 125 for evaluation. Classifier 125 generates feature vectors for evaluation by machine learning model 126. Generating a feature vector for a request may include parsing data and encoding the data as one or more feature vectors for machine learning processing by ML model 126. The generated feature vector for a request, according to one embodiment, comprises features representing one or more of the URL, method, domain, query string information, protocol version information, header information, request body information, header metadata, or cookie information. In some embodiments, classifier 125 can selectively turn on or off features for a request based on the data extracted from the request being evaluated.

Example features that can be extracted from a request and represented in a feature vector for classification include, but are not limited to:
(1) Method.
(2) URL information:
   2a. URL string;
   2b. Select portion(s) of the URL string:
   2b (i). Scheme specified in URL;
   2b (ii). Subdomain,
   2b (iii). Top-level domain,
   2b (iv). Second-level domain,
   2b (v). Subdirectory,
   2b (vi.) Port,
   2b (vii.) Query parameters,
   2b (viii). Fragments.
(3) Protocol version specified in request.
(4) Hostname (e.g., domain specified in hostname field of HTTP request)
(5) Header information:
   5a. Header names.
   5b. Header values.
   5c. Header directives/attributes
(6) Cookie information:
   6a. Cookie names.
   6b. Cookie values.
   6c. Cookie directives/attributes.
(7) Header metadata, such as header size or other metadata about the headers included in the request.
(8) Request body information:
   8a. The request body text;
   8b. Metadata about the request body, such as the request body size, or other information about the request body.

Classifier 125 processes requests and outputs request action classifications for the requests. In some embodiments, a request action classification includes all the class labels from the label space and the respective confidence scores for the classes determined by classifier 125. In other embodiments, the request action classification includes the n highest confidence labels and associated confidence scores. For example, if n=1 and machine learning model 126 of classifier 125 classifies a request with the following confidence scores: Download (0.7), Upload (0.1), Other (0.2), the request action classification includes Download (0.7), but not the other labels or confidence scores. In yet another embodiment, classifier 125 outputs the highest confidence label as the request action classification.

Proxy server 120 further makes the requests and request action classifications assigned to the requests by classifier 125 available to downstream components via the application programming interface (API) 127 or another interface. Various downstream tasks, such as deep packet inspection (DPI), allowing/denying requests, recording security logs, or other tasks can be performed based on the classifications.

Data loss prevention service 132 continuously accesses new requests and respective request action classifications from API 127 and applies rules to block the requests, allow the requests or to take other actions. The rules applied consider the classification assigned to the request and may also consider other factors related to the request such as, but not limited to, the target cloud service, the user making the request, the client computer making the request (e.g., based on one or more of host name, IP address, MAC address, or other characteristics of the client computer). If data loss prevention service 132 determines that the request is an allowable request according to the rules, data loss prevention service 132 allows the request to be forwarded to the cloud service. Analytics component 134 accesses requests and assigned request action classifications and performs various analytics.

Proxy server 120 provides the assigned request action classification to data loss prevention service 132 via API 127 or another interface. Data loss prevention service 132 executes rules based on the assigned classification to determine which actions to take with respect to the request. Example rules include:
if the highest confidence class=<class> then <system action>.
if the highest confidence class=<class> and the highest confidence score is greater than <threshold>, then <system action>.
if the confidence score for <class> is greater than <threshold>, then <system action>.

In the above examples, <class> is a specified class, such as Download, <threshold> is a confidence score threshold, and <system action> is a specified system action. In one embodiment, the system action includes at least one of: blocking the request; initiating DPI; or recording a security log for the request.

Initiating DPI, according to one embodiment, can include one or more of: initiating DPI of packets from specific sources on network 104 (e.g., devices or applications) to specific destinations on network 108 (e.g., websites, cloud services, IP addresses); initiating DPI of packets from network 104 to specific destinations on network 108, regardless of source on network 104; initiating DPI of packets from specific sources on network 104 to network 108, regardless of destination on network 108; initiating DPI of packets from network 104 to network 108 regardless of source or destination; initiating DPI of packets from network 108 from specific sources to specific destinations on network 104; initiating DPI of packets from network 108 to specific destinations on network 104, regardless of source; initiating DPI of packets from network 108 from specific sources to network 104, regardless of destination on network 104; or initiating DPI of packets from network 108 to network 104 regardless of source or destination.

Using the example of triggering DPI based on a request from client application 110b to cloud application 112a, data loss prevention service 132 may trigger DPI of one or more of: packets from client application 110b to cloud application 112a, but not other packets from client device 102b; packets from client application 110b to network 108, but not other packets from client device 102b; packets from client device 102b to cloud application 112a, regardless of originating client application on client device 102b; packets from client device 102b to network 108, regardless of originating client application on client device 102b; packets from cloud application 112a to client device 102b regardless of target client application on client device 102b; packets from cloud application 112a to client application 110b, but not packets to other client applications on client device 102b; packets from cloud application 112a to network 104 regardless of destination; or packets from network 108 to network 104, regardless of source or destination.

As discussed above, the rules applied by data loss prevention service 132 may also consider other factors related to the request such as, but not limited to, the target cloud service, the user making the request, the client computer making the request (e.g., based on one or more of host name, IP address, MAC address, or another characteristic of the client computer).

In some embodiments, proxy server 120 includes multiple classifiers (e.g., a second classifier 125′ is illustrated, though proxy server 120 may include additional classifiers), which may be trained for different use cases or label spaces. As an illustrative example, classifier 125 may be trained to classify requests to cloud file systems, while classifier 125′ is trained to classify requests to social media sites.

Proxy server 120 can include routing logic to route requests between classifiers. In one embodiment, proxy server 120 routes requests to the appropriate classifier based on the URL, destination domain, request source or other characteristic associated with the request. For example, proxy server 120 may include routing logic to requests directed to file sharing services to classifier 125 and requests directed to social media sites to second classifier 125′.

As another example of routing logic, one embodiment of proxy server 120 routes each request through the classifiers until a threshold level of confidence is achieved for a class, the request has been processed for all or a defined subset of the classifiers or another criterion is met. Say that a threshold is set to 0.7, but classifier 125 returns the following request action classification confidence scores: Upload (0.4), Download (0.5), Other (0.1); then proxy server 120 will route the request to second classifier 125′ because none of the confidence scores from the first classifier meet the confidence threshold of 0.7. This process may continue until the threshold level of confidence is achieved for a class, the request has been processed for all or a defined subset of the classifiers, or another criterion is met.

As yet another example of routing logic, one embodiment of proxy server 120 routes requests through the classifiers based on a class confidence score meeting a threshold. Say for example, the classifier 125 also includes an Other class, the routing logic uses a threshold of 0.8 for the Other class, and classifier 125 returns a request action classification of: Upload (0.05), Download (0.05), Other (0.9) for a request; then proxy server 120 routes the request to the second classifier 125′ based on the confidence score of Other meeting the threshold of 0.8. Other types of routing logic may also be used.

While illustrated separately, one or more classifiers (e.g., classifier 125 and classifier 125′) may be combined as a classifier using, for example, ensemble techniques. In one example of such an embodiment, a classifier may be trained for each use case. The classification scores generated for a request by each classifier can be combined using a decision tree, direct acyclic graph or other ensemble method.

In addition, or in the alternative, to cloud services intelligence system 100 classifying requests, cloud services intelligence system 100 includes one or more classifiers to classify responses. FIG. 1B is a diagrammatic representation of one embodiment of cloud services intelligence system 100 configured to classify responses from cloud services. In the embodiment of FIG. 1B, proxy server 120 of cloud services intelligence system 100 uses a machine learning classifier 145 to classify responses from cloud services.

Client applications 110 or components of network 104 are configured such that requests by client applications 110 to the Internet are routed to proxy server 120, which acts as an intermediary between client applications 110 on network 104 and web services provided by cloud applications 112 over network 108. Thus, responses from network 108 (e.g., from cloud applications 112) are returned to proxy server 120. Proxy server 120 classifies responses using machine learning classifier 145. Downstream components can use the classifications for analytics or to implement tasks with respect to the responses. For example, data loss prevention service 132 can use the class assigned to a response to block or allow the response.

Classifier 145 includes one or more machine learning models 146 trained to classify responses based on attempted interactions with, for example, cloud services. Classifier 145 may utilize an artificial neural network (ANN), a decision tree, association rules, inductive logic, a support vector machine, clustering analysis, or Bayesian networks, among other examples. Examples of action classes (labels) that reflect interactions with cloud services are discussed above.

In some embodiments, classifier 145 includes multiple machine learning models 146 for different feature sets or different use cases. For example, classifier 145 may include a machine learning model 146 trained on a first feature set, a second machine learning model trained on a second feature, a third machine learning model trained on a third feature set and so on. The resulting classification scores generated by each ML model may then be combined into a final classification score using a decision tree or other technique. In yet another example of feature classification evaluation, a classification may be subdivided into a multi-class classification problem defined by the label set for classifier 145. For example, for a classifier 145 to classify responses according to the label space of Upload, Download, Other, a classification may be subdivided into a three-class classification problem defined by Upload responses, Download response and Other responses. The resulting multi-class problem can be solved using multi-class classification (e.g., Directed Acyclic Graph (DAG) support vector machine or other multi-class classification techniques).

Classifier 145 is trained using a training corpus of HTTP responses in which the responses are labeled according to the label space for classifier 145. In other words, classifier 145 is trained from a collection of data that includes responses that are known to be of each class for which the classifier is trained. For example, classifier 145 can be trained to classify responses as Upload, Download, or Other from a collection of data including known Download responses and known Upload responses. In some embodiments, Other is not a trained category but a catchall category used by classifier 145 if it cannot classify a response into Upload or Download with a threshold degree of confidence. In other embodiments, the collection of data used to train classifier 145 includes known Other responses (responses that are known not to be Upload or Download responses).

In a training stage, collected responses are analyzed to extract features that may indicate that a response belongs to a class. Any number of features may be collected and analyzed for a response. During training, feature selection (feature pruning) techniques can be used to reduce the number of features to those that best discriminate between the classes of the label space.

In a classification stage, proxy server 120 routes responses to classifier 145 for evaluation. Classifier 145 generates feature vectors for evaluation by machine learning model 146. Generating a feature vector for a response may include parsing data and encoding the data as one or more feature vectors for machine learning processing by ML model 146. According to one embodiment, the feature vector comprises features representing one or more of the response status, response content information, response cookie information, or response header information. In some embodiments, classifier 145 can selectively turn on or off features for a response based on the data extracted from the response being evaluated.

Example features that can be extracted from a request and represented in a feature vector for classification include, but are not limited to:
(1) Response status information:
   1a. Response status code.
   1b. Response status text.
(2) Header information:
   2a. Header names.
   2b. Header values.
   2c. Header directives/attributes
(3) Cookie information:
   3a. Cookie names.
   3b. Cookie values.
   3c. Cookie directives/attributes.
(4) Response content information:
   4a. The response content text.
   4b. Metadata about the response content, such as content size and mime type.

Classifier 145 processes responses and output response action classifications for the responses. outputs a response action classification for the response. A response action classification, according to one embodiment, includes the labels (or selected subset of labels) from the label space of classifier 145 with associated confidence scores. In other example embodiments, classifier 145 outputs the highest confidence label as the request action classification.

Proxy server 120 further makes the responses and response action classifications assigned to the responses by classifier 145 available to downstream components via API 127 or another interface. Various downstream tasks, such as deep packet inspection (DPI), allowing/denying responses, recording security logs, or other tasks can be performed based on the classifications.

Data loss prevention service 132 continuously accesses new responses and respective response action classifications from API 127 and applies rules to block the responses, allow the responses or to take other actions. The rules applied consider the classification assigned to the response and may also consider other factors related to the response such as, but not limited to, the user to whom the response is being returned, the computer to which the response is being returned, the site/service returning the response, or the computer returning the response (e.g., based on one or more of host name, IP address, MAC address, or other features of the computer). Some example rules are discussed above in conjunction with FIG. 1A with respect to requests. In one embodiment, if a response is an allowable request according to the rules, data loss prevention service 132 allows the request to be forwarded to the appropriate client application. Analytics component 134 accesses responses and assigned response action classifications and performs various analytics.

In some embodiments, proxy server 120 includes multiple classifiers (e.g., a second classifier 145′ is illustrated, though proxy server 120 may include additional classifiers), which may be trained for different use cases or label spaces. Proxy server 120 can include routing logic to route responses to the appropriate classifier or between classifiers.

While illustrated separately, one or more classifiers (e.g., classifier 145 and classifier 145′) may be combined as a classifier using, for example, ensemble techniques. In one example of such an embodiment, a classifier may be trained for each use case. The classification scores generated for a request by each classifier can be combined using a decision tree, direct acyclic graph or other ensemble method.

While various embodiments have been described above with respect to classifying requests to and responses from cloud services, embodiments may be adapted to classifying requests to other types of websites and services (e.g., non-cloud sites and services) or other types of sites and services.

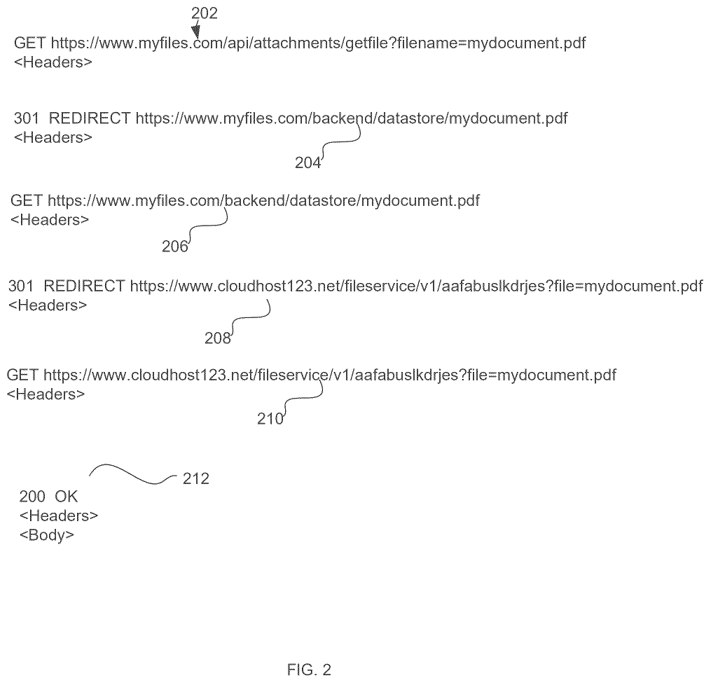

Turning to FIG. 2, an example exchange of URL requests and responses is illustrated. More detailed examples of requests and responses are discussed below. In the example of FIG. 2, a client application sends a request 202 requesting to download a file, but the cloud service returns a response 204 redirecting the client application. The client application then issues a second request (request 206) based on response 204. The cloud service sends response 208 redirecting the client application to a different domain. The client application makes a third request 210, now to the new domain, and the new domain returns the requested file in response 212.

Here, a hard-coded rules-based system that has a rule for GET https://www.myfiles.com/api/attachments/ . . . but not GET www.cloudhost123.net/fileservice/v1/may falsely identify falsely identify request 202 as a Download request even though the file was not downloaded in response to request 202 and fail to identify request 210 as a Download request. However, because a machine learning model can be continually updated with new training requests, machine learning model 126 of FIG. 1A can quickly adapt to the changes in the web service to not identify request 202 as a Download request. Further machine learning model 126 can identify request 210 as a Download request based on its similarity to other download requests, even if the machine learning model was not trained on requests to GET www.cloudhost123.net/fileservice/v1/.

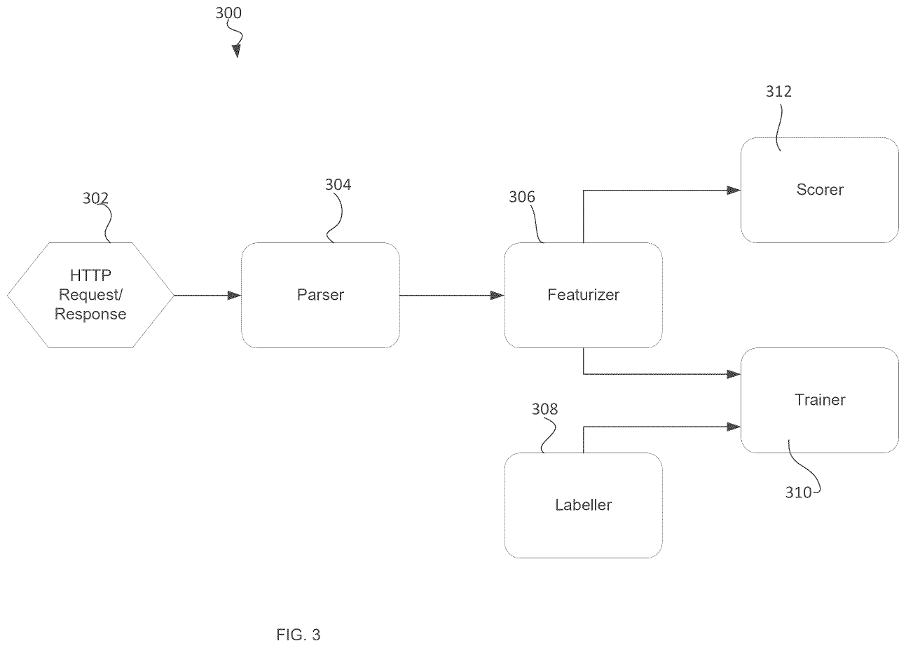

FIG. 3 is a diagrammatic representation of one embodiment of a machine learning classifier 300, such as classifier 125 or classifier 145, processing a request or response. As FIG. 3 illustrates both the training and inference paths for machine learning classifier 300, request/response 302 can represent a request selected as a training example, a response selected as a training example, a request to be classified, or a response to be classified.

Machine learning classifier 300 receives a request or response (represented as request/response 302) for training or inference. Parser 304 is executable to parse request request/response 302 to extract features and pass extracted features to featurizer 306 to generate a feature vector representing the request/response 302. Parser 304 can be configured through rules or learning to ignore certain data in request/response 302. The features represent one or more of a URL, method, status, domain information, query string information, protocol version information, header information, request body information, header metadata, cookie information, or response content information. The features may be extracted, for example, as name: value pairs. In some instances, the value of a feature includes one or more additional features.

According to one embodiment, parser 304 writes the extracted features to a representation of request/response 302 according to a defined syntax—for example, according to JavaScript object notation (JSON), xml or another syntax—for easier encoding to one or more feature vectors. The representation of request/response 302, according to one embodiment, can thus represent one or more unencoded feature vectors. In some embodiments, parser 304 passes the request/response object to featurizer 306 to generate one or respective feature vectors encoded for machine learning processing.

Featurizer 306 generates a feature vector representing the request/response 302. According to one embodiment, the feature vector comprises features representing one or more of the method, status, domain information, query string information, protocol version information, header information, request body information, header metadata, cookie information, or response content information.

According to a more particular embodiment, the feature vector generated for a request comprises features representing one or more of the URL, method, domain information, query string information, protocol version information, header information, request body information, header metadata, or cookie information extracted from the request. In an even more particular embodiment, the feature vector generated for a request comprises features representing the method extracted from the request, the URL extracted for the request, any target headers extracted from the request, any cookies extracted from the request. In some embodiments, the feature vector generated for a request further comprises features representing one or more of request body information, header metadata, or query parameters extracted from the request. The feature vector generated for a response, according to one embodiment, represents one or more of the response status, response content information, response cookie information, or response header information.

Featurizer 306 applies feature encoding techniques to encode the extracted features to generate an encoded feature vector representation of request/response 302. Generating the feature vector may include encoding the extracted features as one or more feature vectors encoded for machine learning processing by trainer 310 or scorer 312. Featurizer 306 can apply various encoding techniques known or developed in the art to converting features into vector representations. Example techniques include, but are not limited to, binning, Boolean labeling, and text-to-number transformation.

For categorical features, such as method and protocol version, techniques such as one hot encoding or mapping to index values may be used. As one example of one hot encoding for HTTP methods, featurizer 306 maps each of the possible values of the “method” feature GET, HEAD, PUT, POST, DELETE, CONNECT, OPTIONS, TRACE, PATCH to different position in a method bit array. When encoding a method feature for a request, featurizer 306 sets the bit at the position corresponding to the method specified in the request.

As another example of categorical feature encoding, featurizer 306 assigns each of GET, HEAD, PUT, POST, DELETE, CONNECT, OPTIONS, TRACE, PATCH to a different index value [0-7]. When encoding a feature vector for a request, featurizer 306 sets the value for the method feature in the feature vector to the corresponding index value. Other techniques for encoding categorical features may also be used.

Numerical value features, such as headersSize, bodySize, response content size, may be encoded using binning or other numerical value encoding techniques.

Non-categorical and non-numeric values (e.g. string text, binary data, pixel information) may be embedded using any of a number of embedding algorithms (such as an autoencoder). According to one embodiment, for example, the URL string, cookie keys and values, header keys and values, and other strings may be embedded using character-level 1-4 n-gram fragment counts for each key and an a tf-idf (term frequency and information document frequency) transformation.

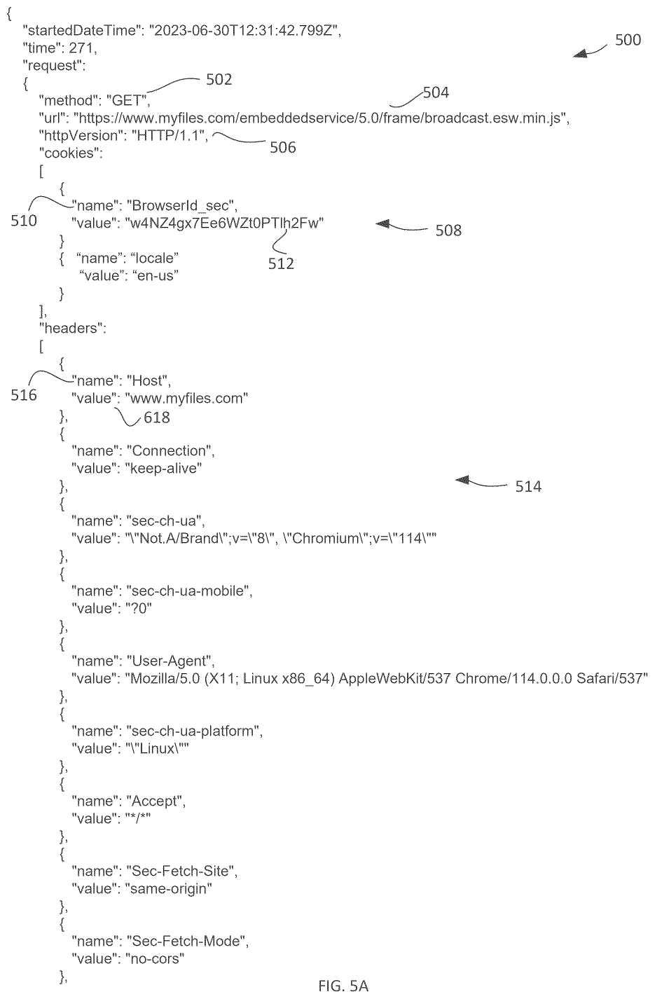

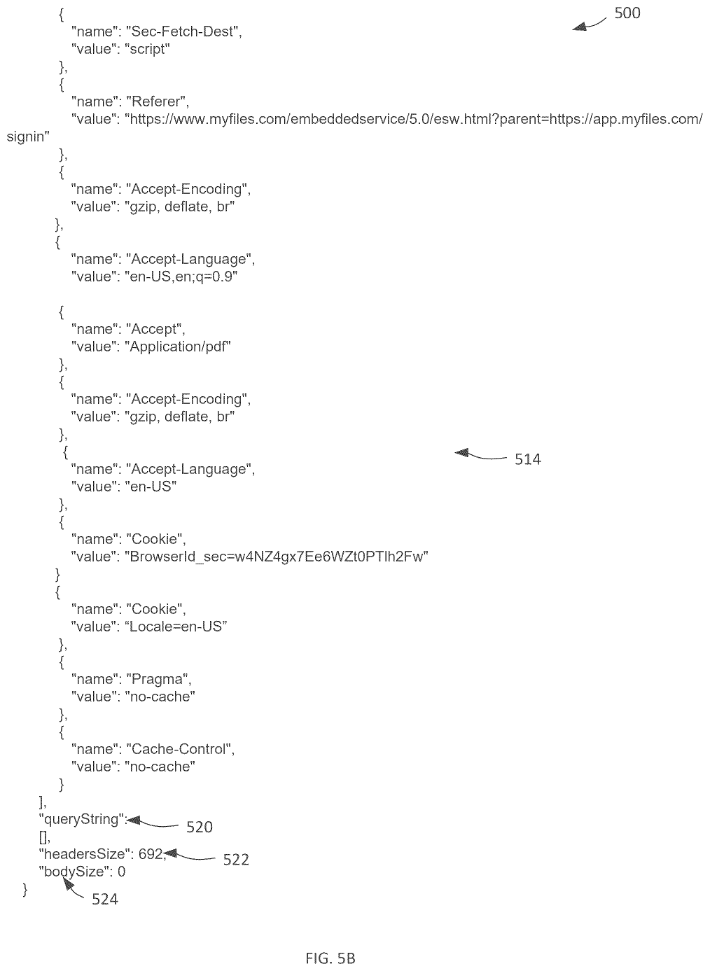

As discussed below, some features may include multiple values or additional features as the values. For such a feature, featurizer 306 can encode the feature's value as, for example, a feature vector. For example, featurizer 306 may encode the value for the request cookies feature 508 of FIG. 5A as a feature vector, such as:
[<index_value_1: <encoded_value_1>, <index_value_2: <encoded_value_2>]
where <index_value_1> is the index in the feature vector of “BrowserId_sec”, <encoded_value_1> is the encoded representation of “w4NZ4gx7Ee6WZt0PTlh2Fw”, <index_value_2> is the index of “locale”, and <encoded_value_2> is the encoded numerical representation of “en-us”.

In some embodiments, featurizer 306 can use Boolean flags in the feature vector or other techniques to indicate the presence or absence of features or feature values in request/response 302 or to distinguish between feature values that are missing, zero, or Null.

The example encoding techniques are merely illustrative examples. Featurizer 306 may implement additional encoding techniques or alternative encoding techniques.

Training requests/responses are labeled according to the label space being trained. To this end, machine learning classifier 300 comprises a labeler 308 that provides an interface for labeling data. A user or process can thus assign the appropriate label to request/response 302. Labeler 308 provides the label for request/response 302 to trainer 310 as part of the training corpus.

In one embodiment, each label in the label space of the machine learning model being trained is assigned an index value. The index value for the label assigned to a response or request is appended to the feature vector representing the response request. For example, the index value for a label assigned to request/response 302 is appended to the feature vector generated for request/response 302.

Trainer 310 implements a machine learning training algorithm to train scorer 312. Given a training set of examples of each class being trained, trainer 310 identifies the features and patterns in the extracted data to classify requests or responses according to classes to generate a trained machine learning model (e.g., scorer 312). In some embodiments, trainer 310 implements feature pruning to reduce the number of features considered by the model to the subset that best discriminates between the classes. Trainer 310 can provide the feature set to parser 304 for use in parsing requests and responses at the classification stage.

At the classification stage, parser 304 may be configured through rules or training to ignore certain data from request/response 302 when extracting features from request/response 302 or providing features to featurizer 306. For example, if trainer 310 determines that the header “Connection” is of low value in classifying requests, trainer 310 may configure parser 304 to ignore the “Connection” header for inference. In one embodiment of feature selection, parser 304 then ignores the “Connection” header when extracting features from requests for inference. In another embodiment of feature selection, parser 304 may still extract the “Connection” header feature to collect an entire set of feature data, but not include it in the features passed to featurizer 306.

At the classification stage, featurizer 306 provides the feature vector generated for request/response 302 to scorer 312. Scorer 312 outputs confidence levels for one or more labels in the label space and, in some embodiments, includes further rules to generate a request/response action classification based on the determined confidence levels.

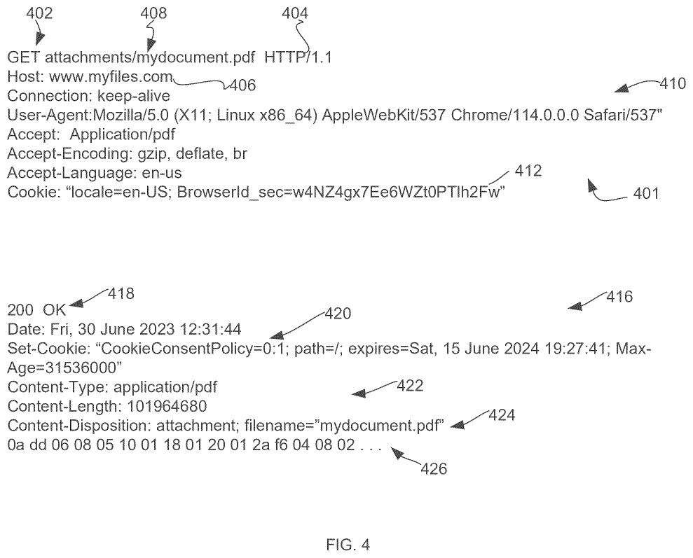

FIG. 4 illustrates an embodiment of an example HTTP request 401 and response 416. As will be appreciated, an HTTP request comprises a method 402, protocol version 404, domain name 406, path 408 to a resource, non-cookie headers 410 and cookies (e.g., cookie 412). An HTTP request is directed to a uniform resource locator that comprises scheme, domain name and in some cases, a path and query parameters (example URLs are illustrated in FIG. 2). The features extracted from a request for training or inference represent one or more of the URL, method, domain, query string information, protocol version information, header information, request body information, header metadata, or cookie information.

HTTP response 416 includes a status 418, cookies 420, headers 422, and response content information including response content header 424 and response content 426. According to one embodiment, features extracted from the response represent one or more of the status, content information, cookie information, or header information.

As discussed, in some embodiments, responses and requests can be represented as corresponding request/response objects in cloud services intelligence system 100. FIG. 5A and FIG. 5B (collectively FIG. 5) illustrate one embodiment of a JSON object representation of a request object 500. Here, request object 500 includes features representing the URL, method, protocol version information, header information, request body information, header metadata, and cookie information. More particularly, request object 500 includes method feature 502, URL feature 504, protocol version feature 506, request cookies feature 508, request headers feature 514, queryString feature 520, headersSize feature 522, and bodySize feature 524. In one embodiment, parser 304 parses requests to populate request objects.

Method feature 502. The value of method feature 502 is the name of the HTTP method extracted from the request.

URL feature 504. The value of URL feature 504 is a URL string extracted for the request. In some embodiments, the URL string includes each of the following if they were included for the request: scheme, subdomain, top-level domain, second-level domain, subdirectory, port, query string, fragments. In the example of FIG. 5A, the URL string includes scheme (“https”), subdomain (“www”), second-level domain (“myfiles”), top-level domain (“com”), and subdirectory (“/embeddedservice/5.0/frame/broadcast.esw.min.js”).

In addition, or in the alternative, to URL feature 504 storing the entire URL string from the request as a feature, different portions of the URL may be extracted as features. For example, the top-level domain may be extracted as one feature, the domain name as another feature, the directory path as yet another feature, and so on.

Protocol version feature 506. The value of protocol version feature 506 is the protocol version specified in the request.

Request cookies feature 508. The request is parsed to identify “Cookie” headers and the names and values of the cookies included in the “Cookie” headers are extracted as cookie features. The value of request cookies feature 508 is an array representation of cookies identified from the request, where each cookie is represented in the array by a cookie object that includes a cookie “name” feature (e.g., feature 510) and a cookie “value” feature (e.g., feature 512) to respectively hold the name and value of a respective cookie from the request.

The cookie features extracted for a cookie may also include features representing additional directives or attributes specified for the cookie in the request. In one embodiment, additional directives or attributes specified for a cookie in the request may be represented in the respective cookie object as features using, for example, the attribute/directive names and values from the request.

In the illustrated embodiment, request cookies feature 508 represents the collection of cookies extracted from the request. In addition, or in the alternative, individual cookies may be represented as features independent of the collection.

In some embodiments, the request is parsed to identify and extract only those target cookies having specified characteristics (e.g., cookies with specific names), while ignoring others. In other embodiments, all cookies in the request are identified and extracted.

Request headers feature 514. The request is parsed to identify headers included in the request and header features representing one or more of the identified headers are extracted. Examples of headers include, but are not limited to, A-IM, Accept, Accept-Charset, Accept-Datetime, Accept-Encoding, Accept-Language, Access Control-Control-Request-Method, Access-Control-Request-Header, Authorization, Cookie, Cache-Control, Connection, Content-Encoding, Content-Length, Content-MD5, Content-Type, Date, Expect, Forwarded, From, Host, HTTP2-Settings, If-Match, If-Modified-Since, If-None-Match, If-Range, If-Unmodified-Since, Max-Forwards, Origin, Pragma, Prefer, Proxy-Authorization, Range, Referer, Referrer-Policy, TE, Trailer, Transfer-Encoding, User-Agent, Upgrade, Via, Warning, Upgrade-Insecure-Requests, X-Requested-With, DNT, X-Forwarded-For, X-Forwarded-Host, X-Forwarded-Proto, Front-End-Https, X-Request-ID, Save-Data, Sec-GPC, Sec-Fetch-Site, Sec-Fetch-Mode, Sec-Fetch-User, Sec-Fetch-Dest. As will be appreciated, one header is “Cookie”. As such, cookie features may be extracted, in some embodiments, as part of extracting header features.

In some embodiments, the request is parsed to identify and extract only those target headers having specified characteristics (e.g., headers with specific names), while ignoring others. In other embodiments, all headers in the request are identified and extracted.

In the illustrated embodiment, the value of request headers feature 514 is an array of headers, where each header is represented by a header object that includes a header “name” feature (e.g., feature 510) and a header “value” feature (e.g., feature 512) to respectively hold the name and value of the respective header. The header features extracted for a header may also include features representing additional directives or attributes specified for the header in the request. In one embodiment, additional directives or attributes specified for a header in the request may be represented in the respective header object as features using, for example, the attribute/directive names and values from the request.

In the illustrated embodiment, request headers feature 514 represents the collection of headers extracted from the request. In addition, or in the alternative, individual headers may be represented as features independent of the collection.

queryString feature 520 holds query string information. According to one embodiment, the value of queryString feature 520 is an array of query parameters extracted from the query string of the URL request, represented in the array as corresponding name: value pairs using the parameter names and values from the query string. For example, the query string from the URL is parsed to extract key: value pairs from the query string and key: value pairs are stored as the value of queryString feature 520 as an array of name: value pairs. In the illustrated embodiment, the URL did not include a query string and, thus, the value of queryString feature 520 is empty.

In another embodiment, each query parameter is represented as a JSON query parameter object having a parameter “name” feature to hold the parameter key and a parameter “value” feature to hold the parameter value (e.g., similar to how individual cookies and headers are represented with the cookie/header name held by one feature in the cookie/header object and the respective cookie/header value held by another feature in the respective cookie/header object).

In the illustrated embodiment, queryString feature 520 represents the collection of query string parameters extracted from the request. In addition, or in the alternative, query string parameters may be represented as individual features or parameter objects, independent of the collection.

Request header metadata includes information about the request header. For example, request object 500 includes a headersSize feature 522 with a value “692”. In one embodiment, the value of headersSize feature 522 is determined by the system—for example, by parser 304—summing the sizes of the headers extracted from the request.

Request body data includes features representing request body information. The request body information can include information extracted from the request about the body of the request, such as body metadata extracted from the request or derived from or about the request body. In the illustrated example, request body data includes a bodySize feature 524 having a value derived from the request based on the request body. In one embodiment, the value of bodySize feature 524 is determined by analyzing the request to calculate the body size. Here, the value is 0, indicating that the request did not contain a body.

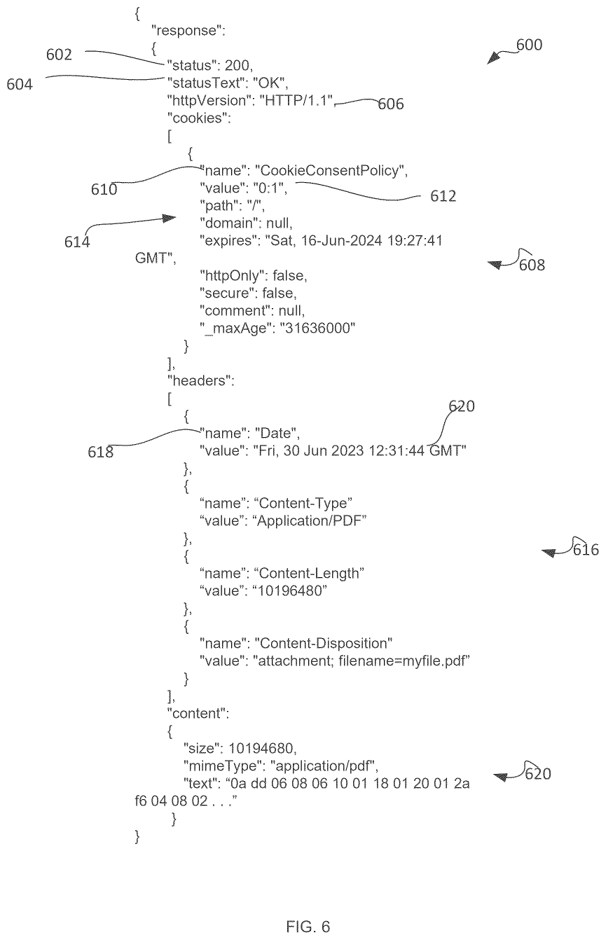

FIG. 6 illustrates one embodiment of a JSON object representation of a response object 600. Here, response object 600 includes features representing response status information, protocol version information, response cookie information, response header information, and response content information. More particularly, response object 600 includes status feature 602, status text feature 604, response protocol version feature 606, response cookies feature 608, response headers feature 616, and response content feature 620. In one embodiment, parser 304 parses responses to populate response objects.

Status feature 602 and status text feature 604. The value of status feature 602 is a status code extracted from the response and the value of status text feature 604 is the status text extracted from the response.

Response protocol version feature 606. The value of protocol version feature 606 is the protocol version specified by the HTTP response.

Response cookies feature 608. The response is parsed to identify “Set-Cookie” headers and features representing the cookies to be set by the header are extracted. The value of response cookies feature 608 is an array representation of cookies identified from the response. Each cookie is represented in the array by a corresponding JSON cookie object having a cookie “name” feature (e.g., feature 610) and a cookie “value” feature (e.g., feature 612) for respectively holding the name and value of a respective cookie.

The cookie features extracted for a cookie may also include features representing additional directives or attributes specified for the cookie in the response. In one embodiment, additional directives or attributes specified for a cookie in the response may be represented in the respective cookie object as features using, for example, the attribute/directive names and values from the request. In FIG. 6, for instance, the response cookie object for “CookieConsentPolicy” includes additional features 614 representing additional directives/attributes extracted from the response for the “CookieConsentPolicy” cookie.

In the illustrated embodiment, response cookies feature 608 represents the collection of cookies extracted from the response. In addition, or in the alternative, individual cookies may be represented by features independent of the collection.

In some embodiments, the response is parsed to identify and extract only those target cookies having specified characteristics (e.g., cookies with specific names), while ignoring others. In other embodiments, all cookies set in the response are identified and extracted.

Response headers feature 616. The request is parsed to identify headers included in the response and header features representing one or more of the identified headers are extracted. Examples of response headers include, but are not limited to, Accept-CH, Access-Control-Allow-Origin, Access-Control-Allow-Credentials, Access-Control-Expose-Headers, Access-Control-Max-Age, Access-Control-Allow-Methods, Access-Control-Allow-Headers, Clear-Site-Data Accept-Patch, Accept-Ranges, Age, Allow, Alt-Svc, Cache-Control, Connection, Content-Disposition, Content-Encoding, Content-Language, Content-Length, Content-Location, Content-MD5, Content-Range, Content-Type, Date, Delta-Base, ETag, Expires, IM, Last-Modified, Link, Location, Pragma, Preference-Applied, Proxy-Authenticate, Retry-After, Server, Set-Cookie, Strict-Transport-Security, Trailer, Transfer-Encoding, Tk, Upgrade, Vary, Via, Warning, WWW-Authenticate, X-Frame-Options, Content-Security-Policy, NEL, Permissions-Policy, Refresh, Report-To, Status, Timing-Allow-Origin, X-Content-Duration, X-Content-Type-Options, X-Powered-By, X-Redirect-By, X-Request-ID, X-Correlation-ID, X-XSS-Protection.

In the illustrated embodiment, the value of response headers feature 616 is an array of headers in which each header is represented as a corresponding JSON header object having a header “name” feature (feature 618) and a header “value” feature (feature 620). The header features extracted for a header may also include features representing additional directives or attributes specified for the header in the response. In one embodiment, additional directives or attributes specified for a header in the response may be represented in the respective header object as features using, for example, the attribute/directive names and values from the request.

In the illustrated embodiment, response headers feature 616 represents the collection of headers extracted from the request. In addition, or in the alternative, individual headers may be represented as features independent of the collection.

In some embodiments, the response is parsed to identify and extract only those target headers having specified characteristics (e.g., headers with specific names), while ignoring others. In other embodiments, all headers in the response are identified and extracted.

Response content feature 620 includes features representing response content information. The content information can include information contained in the response about the content of the response or derived from or about the response content. In the illustrated embodiment, the value of response content feature 620 a JSON response content object that includes features for the size of the content (e.g., size:101094680), the mimeType of the content (e.g., mime Type:application/pdf) and the content text (e.g., text: 0a dd 06 08 05 10 01 18 01 20 01 2a f6 04 08 02 . . . ) (the response content text is truncated for brevity).

FIG. 5 and FIG. 6 are merely illustrative examples. Embodiments may, for example, implement additional features or alternative features or omit features. Embodiments may use any suitable syntax or structure for representing extracted features.

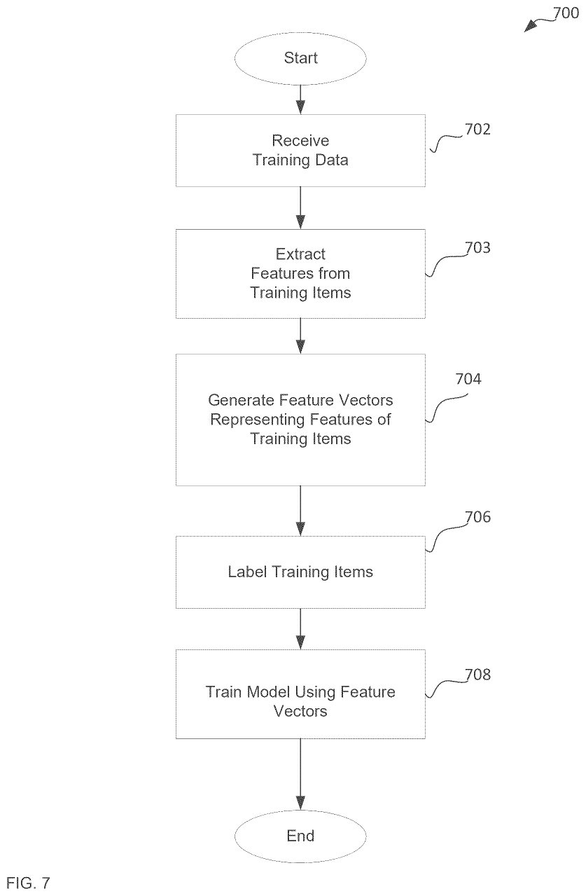

FIG. 7 is a flowchart illustrating one embodiment of a process for training a classifier to classify requests or responses according to requested actions. As an example, method 700 may be executed by an exemplary system such as cloud services intelligence system 100 of FIG. 1A or FIG. 1B. In one embodiment, the method 700 may be implemented by a machine learning classifier 300 to train scorer 312. The method 700 may be implemented using software, hardware or a combination of software and hardware. In some embodiments, method 700 may be embodied as computer-executable instructions stored on a non-transitory, computer-readable medium.

Method 700 begins at step 702 where items of training data are received (training requests or training responses). The training data may be used to train or retrain a classifier. At step 702, the training items are processed to extract features.

At step 703, features are extracted from the training items. By way of example, but not limitation, the features extracted from a request may represent one or more of one or more of the URL, method, domain, query string information, protocol version information, header information, request body information, header metadata, or cookie information. In a particular embodiment, the extracted features comprise features representing the HTTP method extracted from the request, the URL string for the request, target headers (names and values) identified in the request, cookies (names and values) identified in the request, and query parameters extracted from the request. The features extracted from a response may represent one or more of the response status, response content information, response cookie information, or response header information.

At step 704, extracted features are encoded as a feature vector. By way of example, but not limitation, the feature vector generated for a request includes features representing one or more of one or more of the URL, method, domain, query string information, protocol version information, header information, request body information, header metadata, or cookie information. In an even more particular embodiment, the feature vector generated for a request includes features representing the HTTP method extracted from the request, the URL string for the request, target headers (names and values) identified in the request, cookies (names and values) identified in the request, and query parameters extracted from the request. According to one embodiment, the feature vector generated for a response includes features representing one or more of the response status, response content information, response cookie information, or response header information.

At step 706, the training data is labeled. For example, a user or process can assign the appropriate request/response action label to each training request or response. The encoded value for a label assigned to a training request or response is appended to the feature vector for the request/response.

At step 708, the training corpus is used to train a machine learning classifier to classify requests or responses according to the request/response actions. The trained classifier is deployed to a network. For example, the trained classifier may be deployed to a proxy server in one embodiment.

FIG. 7 is merely an illustrative example, and the disclosed subject matter is not limited to the ordering or number of steps illustrated. Embodiments may implement additional steps or alternative steps, omit steps, or repeat steps.

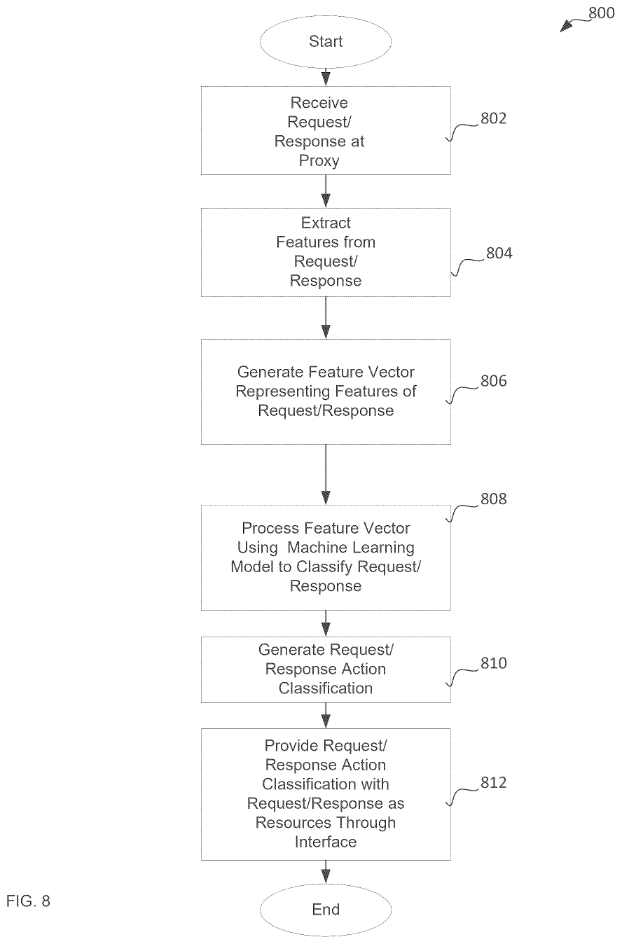

FIG. 8 is a flowchart illustrating one embodiment of method 800 of classifying requests to online services according to requested actions. One or more steps of method 800 may be implemented using software, hardware or a combination of software and hardware. In some embodiments, method 800 may be embodied as computer-e instructions stored on a non-transitory, computer-readable medium. In an even more particular embodiment, one or more steps of method 800 are implemented at a proxy server, such as proxy server 120.

In some embodiments, a network is configured to use a proxy server for requests between client applications on a network and web services, such as cloud services, offered over the internet. As such, at step 802, a proxy server receives a request from a client application to a web service or response from a web service to a client application.

The proxy server includes a trained machine learning classifier. At step 804, the machine learning classifier extracts features from the request or response. By way of example, but not limitation, the features extracted from a request may represent one or more of one or more of the URL, method, domain, query string information, protocol version information, header information, request body information, header metadata, or cookie information. In a particular embodiment, the extracted features comprise features representing the HTTP method extracted from the request, the URL string for the request, target headers (names and values) identified in the request, cookies (names and values) identified in the request, and query parameters extracted from the request. The features extracted from a response may represent one or more of the response status, response content information, response cookie information, or response header information. The features extracted from a response may represent one or more of the response status, response content information, response cookie information, or response header information.

At step 806, the machine learning classifier generates a feature vector representing the request or response. Generating the feature vector may include parsing data and encoding the data as one or more feature vectors for machine learning processing by a machine learning model (e.g., machine learning model 126, machine learning model 146). The feature vector generated for a request includes features representing one or more of one or more of the URL, method, domain, query string information, protocol version information, header information, request body information, header metadata, or cookie information. In an even more particular embodiment, the feature vector generated for a request includes features representing the HTTP method extracted from the request, the URL string for the request, target headers (names and values) identified in the request, cookies (names and values) identified in the request, and query parameters extracted from the request. According to one embodiment, the feature vector generated for a response includes features representing one or more of the response status, response content information, response cookie information, or response header information.

At step 808, the machine learning classifier evaluates the feature vector representing the request or the response to classify the response. According to one embodiment, the trained machine learning model of the classifier may output a classification result that includes all the class labels from the label space and the respective confidence scores for the classes. At step 810, a response action classification or request action classification is generated.

In some embodiments, a request/response action classification includes all the class labels from the label space of the model and the respective confidence scores for the classes as determined for the request/response by the trained machine learning model. In other embodiments, the request action classification includes the n highest confidence labels and associated confidence scores determined for the request/response. In yet another embodiment, the highest confidence label is output as the request action classification for the request.

At step 812, makes the request/response and request/response action classification associated with the request/response available as one or more resources available through an interface.

FIG. 8 is merely an illustrative example, and the disclosed subject matter is not limited to the ordering or number of steps illustrated. Embodiments may implement additional steps or alternative steps, omit steps, or repeat steps.

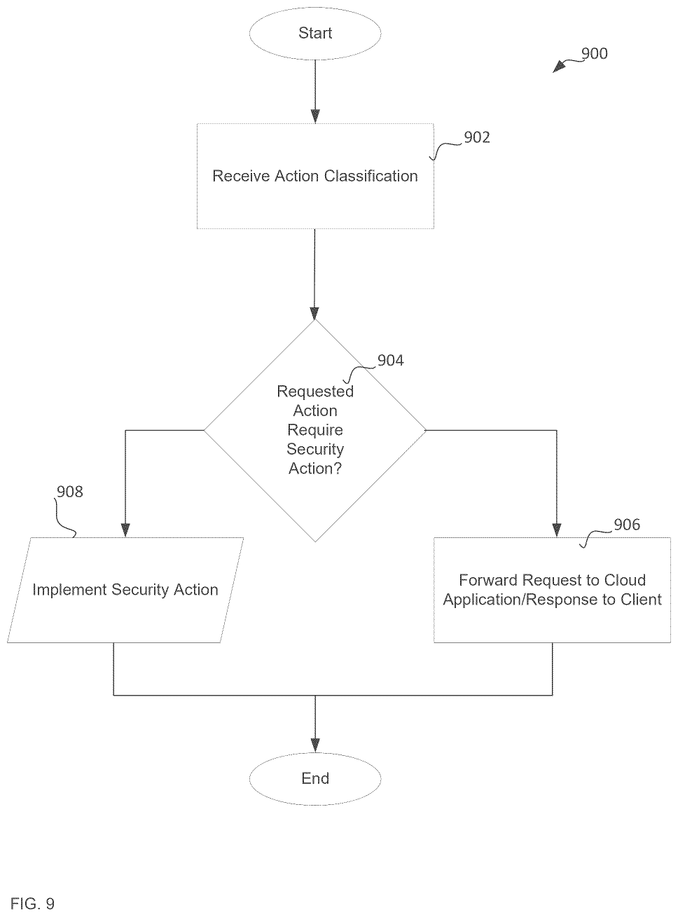

FIG. 9 is a flowchart illustrating one embodiment of method 900 for controlling allowable actions with respect to web services. One or more steps of method 900 may be implemented using software, hardware or a combination of software and hardware. In some embodiments, method 900 may be embodied as software instructions stored on a non-transitory, computer-readable medium. In an even more particular embodiment, one or more steps of method 900 are implemented by a data loss prevention service, such as data loss prevention service 132.

At step 902, a request or response and associated request/response action classification are received.

At step 904, a determination is made whether the request/response requires a security action. The rules applied consider the request/response action classification assigned to the request/response and may also consider other factors related to the request or response such as, but not limited to, the target site/service of a request, the user making the request, the client computer making the request (e.g., based on one or more of host name, IP address, MAC address, or other characteristics of the client computer), the user to whom the response is being returned, the client computer to which the response is being returned, the site/service returning the response, or the computer returning the response (e.g., based on one or more of host name, IP address, MAC address, or other features of the computer). If no security action is required, the request/response is forwarded, at step 906, to the target service/site or client computer.

If the security action is required, the security action is executed at step 908. In some embodiments, the security action includes one or more of blocking the request/response, initiating DPI, or recording a security log.

FIG. 9 is merely an illustrative example, and the disclosed subject matter is not limited to the ordering or number of steps illustrated. Embodiments may implement additional steps or alternative steps, omit steps, or repeat steps.

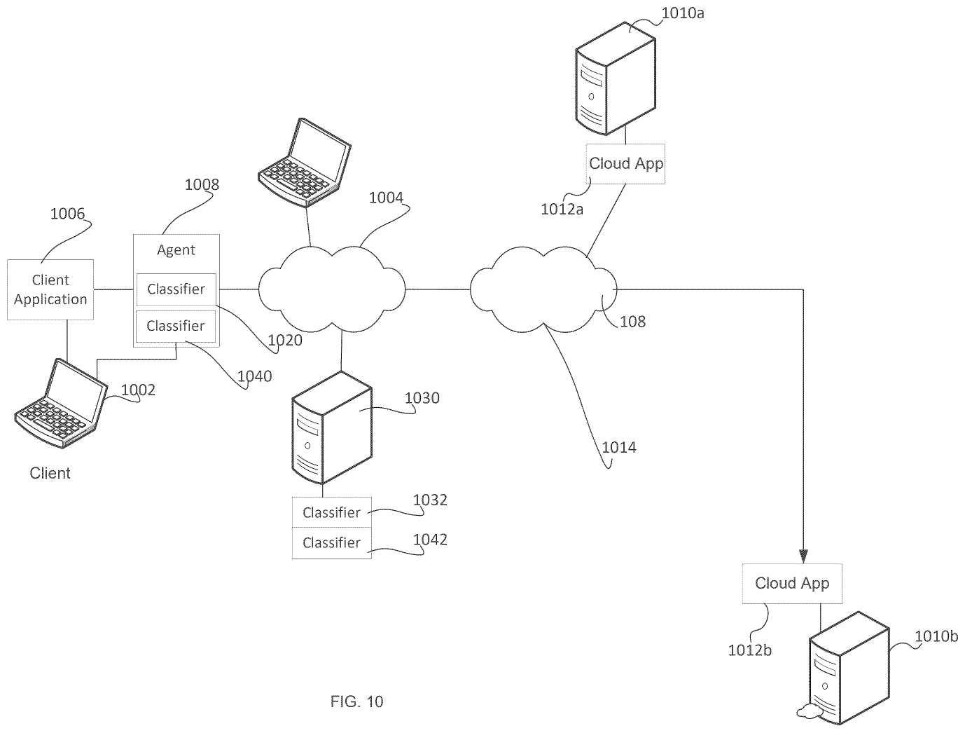

It will be understood that various functions such as feature extraction, feature vector generation, request/response action classification, and the application of security rules to requests or responses can occur at various locations in a network environment. FIG. 10, for example, illustrates an embodiment in which request/response action classification is performed by a local agent 1008 running on a client computer or a server computer system 1030 that is not in the

HTTP request/response path between the client applications of network 1004 and services provided on network 1014.

In the embodiment of FIG. 10, client computers (e.g., client computer 1002) are connected to a network 1004. The client computers run client applications (e.g., client application 1006) and agents (e.g., agent 1008). Cloud computing systems (e.g., cloud computing system 1010a and cloud computing system 1010b are illustrated) run applications (e.g., cloud computing application 1012a and cloud computing application 1012b are illustrated) to provide services over a second network 1014. According to one embodiment, first network 1004 is an intranet, such as a local area network (LAN) or virtual local area network (VLAN), and second network 1014 comprises the Internet.

In the embodiment illustrated, the agents on client devices can intercept requests by client applications, such as requests to services provided over network 1014. For example, agent 1008 may intercept requests from client application 1006 using hooks or other mechanisms. According to one embodiment, agent 1008 includes a classifier 1020 trained to determine request action classifications for the requests.

Agent 1008 applies rules to determine whether to implement security actions based on the requests. The rules applied consider the request action classification assigned to the request and may also consider other factors related to the request, such as, but not limited to, the target site/service of a request, the user making the request, the client computer making the request (e.g., based on one or more of host name, IP address, MAC address, or other characteristics of the client computer). If a security action is required for a request, agent 1008 implements the security action. In some embodiments, the security action includes one or more of blocking the request, initiating DPI, or recording a security log. If no security action is required, agent 1008 allows the request to proceed without a security action by agent 1008.

In another embodiment, server computer system 1030 includes a classifier 1032 trained to output request action classifications for requests. Server computer system 1030 can thus provide a request action classification service that may be utilized by agents running on any number of client devices. According to one embodiment, agent 1008 may thus send request information to server computer system 1030 for request action classification. For example, agent 1008 may extract features from the requests to be classified and send the extracted features to server computer system 1030 for classification by classifier 1032. In another embodiment, agent 1008 sends the requests to server computer system 1030 and classifier 1032 performs the feature extraction. Thus, server computer system 1030 may return the request action classifications to agent 1008.

In some embodiments, server computer system 1030 determines if security actions are required for the requests and sends indications of security actions to agent 1008. If a security action is required for a request, agent 1008 implements the security action. If no security action is required, agent 1008 allows the request to proceed without security action by agent 1008.

In addition, or in the alternative, agent 1008 includes a classifier 1040 trained to output response action classifications. Agent 1008 may intercept responses received from network 1014 and process the responses using classifier 1040 to determine response action classifications for the responses.

Agent 1008 applies rules to determine whether to implement security actions for the responses. The rules applied consider the response action classification assigned to a response and may also consider other factors related to the response, such as, but not limited to, the site/service returning the response, or the computer returning the response (e.g., based on one or more of host name, IP address, MAC address, or other features of the computer). If a security action is required, agent 1008 may implement the security action. In some embodiments, the security action includes one or more of blocking the response, initiating DPI, or recording a security log. If no security action is required, agent 1008 allows client application 1006 to access the response without a security action.

In another embodiment, server computer system 1030 includes a classifier 1042 trained to output response action classifications for responses. Server computer system 1030 can thus provide a response action classification service that may be utilized by agents running on any number of client devices. According to one embodiment, agent 1008 may thus send request information to server computer system 1030 for response action classification. which includes a trained classifier 1042. For example, agent 1008 may extract features from the responses to be classified and send the extracted features to server computer system 1030 for classification by classifier 1042. In another embodiment, agent 1008 sends the requests to server computer system 1030 and classifier 1042 performs the feature extraction. Thus, server computer system 1030 may return the response action classifications to agent 1008.

In some embodiments, server computer system 1030 determines if security actions are required for the responses and sends indications of the security actions to agent 1008. If a security action is required for a response, agent 1008 implements the security action. If no security action is required, agent 1008 allows client application 1006 to access the response.

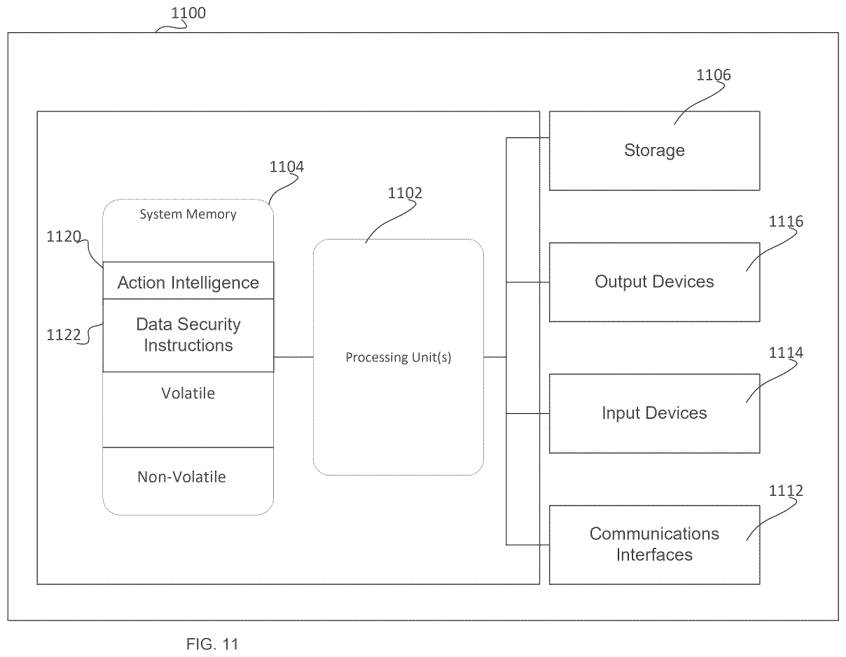

FIG. 11 is a diagrammatic representation of one embodiment of an operating environment 1100 in which one or more of the present embodiments may be implemented. Operating environment may represent one embodiment of cloud services intelligence system 100, a client computer 1002, or server computing system 1030.

This is only one example of a suitable operating environment and is not intended to suggest any limitation as to the scope of use or functionality. Other computing systems, environments, and/or configurations that may be suitable for use. Example operating environments include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

Operating environment 1100 typically includes at least one processing unit 1102 and memory 1104. Depending on the exact configuration and type of computing device, memory 1104 (storing, among other things, executable instructions) may be volatile (such as RAM), non-volatile (such as ROM, flash memory, etc.), or some combination of the two. Further, environment 1100 may also include storage devices 1106, such as, but not limited to, magnetic or optical disks or tape. Similarly, environment 1100 may also have input device(s) 1114 such as keyboard, mouse, pen, voice input, etc. and/or output device(s) 1116 such as a display, speakers, printer, etc. Also included in the environment may be one or more communication interfaces 1112, such as LAN, WAN, point to point, etc.

Operating environment 1100 includes at least some form of non-transitory computer-readable media. The non-transitory computer-readable readable media can be any available media that can be accessed by processing unit 1102 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

The operating environment 1100 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

As stated above, a number of program modules and data files may be stored in the system memory 1104. While executing on the processing unit 1102, program modules (e.g., applications, Input/Output (I/O) management, and other utilities) may perform processes including, but not limited to, one or more of the stages of the operational methods described herein such as methods 700, 800, 900.

In one embodiment, action intelligence component 1120 includes instructions to implement response action classification or request action classification. For example, action intelligence component 1120 represents one embodiment of the instructions of proxy server 120, agent 1008, or a request or response action classification service of server computer system 1030. Data security component 1122 includes instructions for implementing security actions based on action classifications. For example, data security component 1122 represents one embodiment of the instructions for data loss prevention service 132, data security functionality of agent 1008, or data security functionality of server computer system 1030. System memory 1104 may include other program modules such as program modules to provide analytics or other services. Furthermore, the program modules may be distributed across computer systems in some embodiments.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 1100 on the single integrated circuit (chip).

Portions of the methods described herein may be implemented in suitable software code that may reside within RAM, ROM, a hard drive or other non-transitory storage medium. Alternatively, the instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A computer-implemented method for activity monitoring:
accessing a machine learning multiclass classifier, the machine learning multiclass classifier representing HTTP network request features and associated actions with respect to interacting with websites;
receiving an HTTP request;
extracting a feature set from the HTTP request;
determining a request action classification for the HTTP request, determining the request action classification comprising processing the feature set extracted from the HTTP request to the machine learning multiclass classifier to classify the HTTP request; and
providing access to the HTTP request and request action classification via an application programming interface.

2. The computer-implemented method of claim 1, wherein the HTTP request is received, the feature set extracted, and the request action classification determined at an HTTP proxy server.

3. The computer-implemented method of claim 1, further comprising providing the request action classification for the HTTP request to a downstream component for further processing of the HTTP request.

4. The computer-implemented method of claim 1, further comprising providing the HTTP request and the request action classification to a process that automatically initiates a task based on the request action classification, wherein the task comprises at least one of performing a deep packet inspection, allowing the HTTP request, blocking the HTTP request, or logging the HTTP request in a security log.

5. The computer-implemented method of claim 1, wherein the request action classification classifies the HTTP request as an upload request.

6. The computer-implemented method of claim 1, wherein the request action classification classifies the HTTP request as a download request.

7. The computer-implemented method of claim 1, wherein the machine learning multiclass classifier is trained to classify requests as upload requests, download requests, or other requests.

8. The computer-implemented method of claim 1, wherein the feature set comprises one or more of an HTTP method feature, a URL feature, a domain feature, a header feature, or a cookie feature.

9. The computer-implemented method of claim 1, wherein the feature set comprises an HTTP method feature, a URL feature, a domain feature, a header feature, and a cookie feature.

10. A computer program product comprising a non-transitory, computer-readable medium storing thereon computer-executable instructions executable by a processor for:
accessing a machine learning multiclass classifier, the machine learning multiclass classifier representing HTTP network request features and associated actions with respect to interacting with websites;
receiving an HTTP request;
extracting a feature set from the HTTP request;
determining a request action classification for the HTTP request, wherein determining the request action classification comprises processing the feature set extracted from the HTTP request to the machine learning multiclass classifier to classify the HTTP request; and
providing access to the HTTP request and request action classification via an application programming interface.

11. The computer program product of claim 10, wherein the computer-executable instructions are executable to receive the HTTP request, extract the feature set, and determine the request action classification at an HTTP proxy server.

12. The computer program product of claim 10, wherein the HTTP request and the request action classification are accessible through the application programming interface to a downstream component for further processing of the HTTP request.

13. The computer program product of claim 10, further comprising code executable for providing the HTTP request and the request action classification to a process that automatically initiates a task based on the request action classification, wherein the task comprises at least one of performing a deep packet inspection, allowing the HTTP request, blocking the HTTP request, or logging the HTTP request in a security log.

14. The computer program product of claim 10, wherein the request action classification classifies the HTTP request as an upload request.

15. The computer program product of claim 10, wherein the request action classification classifies the HTTP request as a download request.

16. The computer program product of claim 10, wherein the machine learning multiclass classifier is trained to classify requests as upload requests, download requests, or other requests.

17. The computer program product of claim 10, wherein the feature set comprises one or more of an HTTP method feature, a URL feature, a domain feature, a header feature, or a cookie feature.

18. The computer program product of claim 10, wherein the feature set comprises an HTTP method feature, a URL feature, a domain feature, a header feature, and a cookie feature.

19. A computer system comprising:
client computing devices comprising client applications;
a proxy server computer coupled to the client computing devices by a network, the proxy server computer comprising:
a processor;
a machine learning multiclass classifier, the machine learning multiclass classifier representing HTTP network request features and associated actions with respect to interacting with websites; and
proxy server code executable by the processor to provide a proxy server, the proxy server code comprising instructions for:
receiving HTTP requests from the client applications;
determining associated request action classifications for the HTTP requests, determining the associated request action classifications comprising processing features extracted from the HTTP requests using the machine learning multiclass classifier to classify the HTTP requests; and
providing access to the HTTP requests and request action classifications via an application programming interface.

20. The computer system of claim 19, wherein the proxy server code further comprises instructions to allow or deny an HTTP request to a server based on a respective request action classification assigned to the HTTP request.
